(19) United States
(12) Patent Application Publication
(10) Pub. No.: US 2007/0250646 A1
(43) Pub. Date: Oct. 25, 2007

(54) COMMUNICATION MANAGEMENT USING ETHERNET INTERFACE

(76) Inventors: Kwang Chul Jeon, San Diego, CA (US); Gwan-Hee You, San Diego, CA (US); Henry Kim, San Diego, CA (US)

Correspondence Address: DUANE MORRIS, LLP;IP DEPARTMENT, 30 SOUTH 17TH STREET, PHILADELPHIA, PA, 19103-4196, US

(21) Appl. No.: 11/669,604

(22) Filed: Jan. 31, 2007

Related U.S. Application Data
(60) Provisional application No. 60/745,211, filed on Apr. 20, 2006.
(60) Provisional application No. 60/746,337, filed on May 3, 2006.

(51) Int. Cl. G06F 15/16

(52) U.S. Cl. 709/250; 709/253; 714/712; 370/400

(57) ABSTRACT

A system and method for controlling and monitoring a wireless communication device. Communication between a communication manager and a wireless communication device is via Ethernet data, and communication between an Ethernet interface controller and a wireless communication module, both in the wireless communication device is via USB data.

### RELATED APPLICATIONS

This application claims the benefits of priority of U.S. Provisional Patent Application Ser. No. 60/745,211, filed Apr. 20, 2006, and U.S. Provisional Patent Application Ser. No. 60/746,337, filed May 3, 2006, both entitled “Communication Management for CDMA/GSM Device Using Ethernet Interface”. This application is also related to U.S. patent application Ser. No. 11/206,961 and U.S. patent application Ser. No. 11/206,962. The disclosures of all of these applications are hereby incorporated by reference, in their entirety.

### BACKGROUND

1. Field of the Invention

This invention relates to wireless communication devices, and more particularly to managing wireless communication using an Ethernet interface.

2. Background

When communicating between a wireless, or cellular, communication device, such as a Code Division Multiple Access (CDMA) or Global Standard for Mobile Communications (GSM) device, and a computing device, such as a computer, a Universal Asynchronous Receive/Transmitter (UART) controller or Universal Serial Bus (USB) controller is often used. However, to use the UART controller, an appropriate cable is required for connecting the wireless communication device to the UART controller. To use the USB controller, the computing device needs to load and install device driver software compatible with the operating system of the computing device. Use of a special cable or software to communicate with the wireless communication device can be inconvenient.

### SUMMARY

In one implementation, a method for managing communication between a wireless communication device and a computing device comprises: communicating Ethernet data from the computing device, wherein the data includes network data and diagnostic data; assigning a first USB channel to the network data and a second USB channel to the diagnostic data; communicating the first and second USB channels to a wireless communication module; receiving two channels of USB data from the wireless communication module, wherein USB data assigned to the first channel is network data and data assigned to the second channel is diagnostic data; and communicating the network data and diagnostic data to the computing device as Ethernet data.

In another implementation, a system for managing communication between a communication device and a computing device comprises: a communication manager module; an Ethernet interface controller module in communication with the communication manager module; and a wireless communication module in communication with the Ethernet interface controller module and in communication with a wireless network, wherein the communication manager module manages the wireless communication module, and wherein communication between the Ethernet interface controller and the communication manager module comprises Ethernet communication and communication between the Ethernet interface controller module and the wireless communication module comprises USB communication.

In another implementation, a system for managing communication between a communication device and a computing device comprises: a computing device comprising a communication manager module adapted to perform management and diagnostic tasks; and a wireless communication device comprising an Ethernet interface controller module and a wireless communication module, wherein the Ethernet interface controller module is in communication with the communication manager module and the wireless communication module, and the wireless communication module is in communication with a wireless network, wherein communication between the Ethernet interface controller and the communication manager module comprises Ethernet communication and communication between the Ethernet interface controller module and the wireless communication module comprises USB communication, and wherein the communication manager module performs management and diagnostic tasks on the wireless communication module.

In yet another implementation, a system for managing communication between a communication device and a computing device comprises: means for communicating Ethernet data from the computing device, wherein the data includes network data and diagnostic data; means for assigning a first USB channel to the network data and a second USB channel to the diagnostic data; means for communicating the first and second USB channels to a wireless communication module; means for receiving two channels of USB data from the wireless communication module, wherein USB data assigned to the first channel is network data and data assigned to the second channel is diagnostic data; and means for communicating the network data and diagnostic data to the computing device as Ethernet data.

Other features and advantages of the present invention should be apparent from the following description which illustrates, by way of example, aspects of the invention.

### BRIEF DESCRIPTION OF THE DRAWINGS

FIG. 1 is a block diagram of an example system in accordance with aspects of the invention.

FIG. 2 is a block diagram illustrating further details of an implementation of the computing device and wireless communication device of FIG. 1.

FIG. 3 is a block diagram illustrating further detail of an implementation of the Ethernet interface controller.

FIG. 4 is a block diagram illustrating another implementation of the Ethernet interface controller.

FIG. 5 is an example flow diagram of an initialization routine for the Ethernet interface controller.

FIG. 6 is a flowchart illustrating an example of the Ethernet interface controller idle routine.

FIG. 7 is an example flow diagram of an Ethernet interface controller diagnostic data manager routine.

FIG. 8 is an example flow diagram of a Ethernet interface controller traffic idle routine.

FIG. 9 is an example flow diagram of a wireless communication module initialization routine.

FIG. 10 is an example flow diagram of a wireless communication idle routine.

FIG. 11 is an example flow diagram of a wireless communication module diagnostic data manager.

FIG. 12 is an example flow diagram of a wireless communication module traffic idle routine.

FIG. 13 is an example flow diagram of a communication manager for the wireless communication device.

FIG. 14A shows a representation of a computer system and a user.

FIG. 14B shows a block diagram of one implementation of the computer system 1400 in FIG. 14A, including the communication manager for a wireless device.

### DETAILED DESCRIPTION

The following detailed description is directed to certain specific embodiments of the invention. However, the invention can be embodied in a multitude of different systems and methods. In this description, reference is made to the drawings wherein like parts are designated with like numerals throughout.

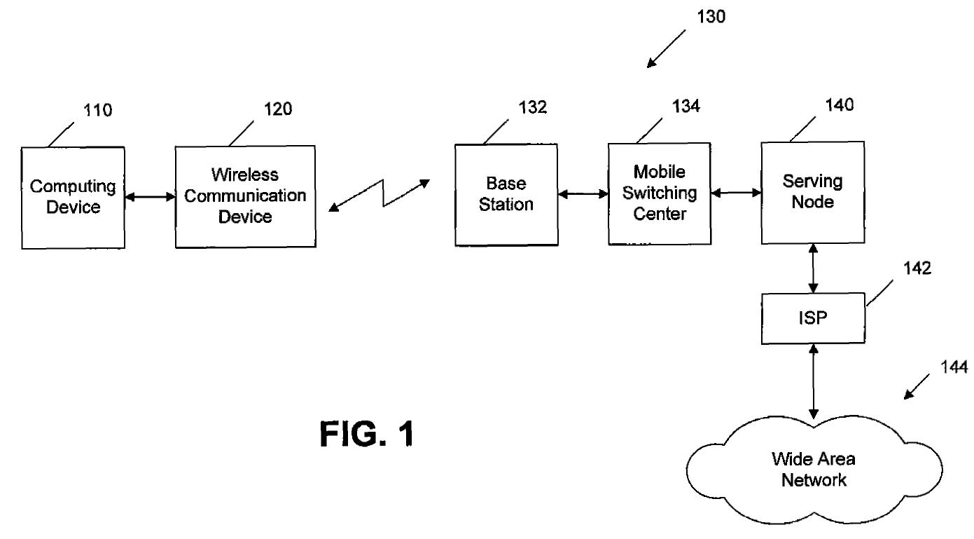

FIG. 1 is a block diagram of an example system in accordance with aspects of the invention. As shown in FIG. 1, a computing device 110 is in communication with a wireless, or cellular, communication device 120. In one embodiment, the computing device 110 communicates with the wireless communication device 120 using an Ethernet connection. Using an Ethernet connection is desirable because an Ethernet connection does not require installation of any additional drivers not already residing on the computing device 120 and can support existing routed networks.

The wireless communication device 120 is in communication with a wireless infrastructure 130. In one embodiment, the wireless infrastructure includes a base station 132 that receives and transmits voice and data traffic to the wireless communication device 120. The wireless infrastructure also includes a mobile switching center 134 that interfaces to a serving node 140. In one embodiment, the serving node 140 is configured as a public switched telephone network (PSTN). In another embodiment, the serving node 140 is configured as a packet data serving node (PDSN). An internet service provider 142 can provide access to the Internet or other wide area network 144. In this way, the computing device 110 can use the wireless communication device 120 to access the Internet 144.

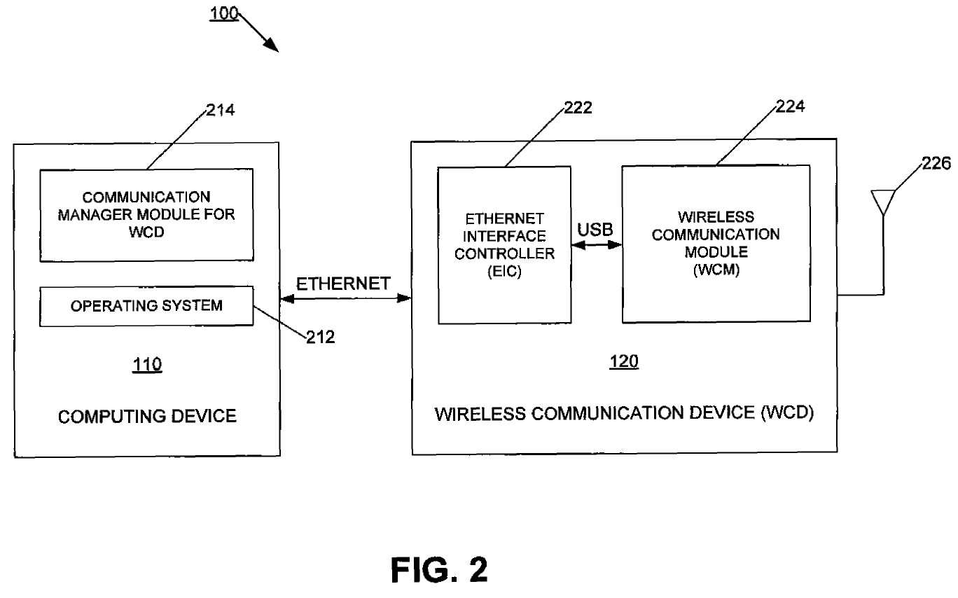

FIG. 2 is a block diagram illustrating further details of an implementation of the computing device 110 and wireless, or cellular, communication device (WCD) 120. As shown in the example of FIG. 2, the computing device 110 includes an operating system 212. The operating system 212 provides an Ethernet driver and a software platform for other application programs in the computing device 110. The computing device 110 also includes a communication manager module 214. In one embodiment, the communication manager module 214 manages communication between the computing device 110 and the wireless communication device 120. The communication manager module 214 can also manage communication between the wireless communication device 120 and the wireless infrastructure 130 and the wide area networks such as the Internet 144.

The wireless communication device 120 includes an Ethernet interface controller 222, a wireless, or cellular, communication module 224, and an antenna 226. In one implementation, the communication manager module 214 provides management and diagnostic tasks for the wireless communication device 120. For example, the communication manager module 214 may perform tasks, such as, accessing system status data, accessing security control features, configuring and modifying service parameters, upgrading system software, performing system tests, collecting system information, downloading and/or debugging system software/firmware, accessing performance status data, and other related tasks.

In another implementation, the communication manager module 214 monitors status of components within the wireless communication device 120, and in response to the status, the communication manager module 214 downloads software updates and/or patches from the Internet for updating the software and/or firmware operating on the wireless communication device 120. Likewise, the communication manager module 214 may download new application software and install the new application on the wireless communication device 120.

As shown in FIG. 2, data communicated between the computing device 110 and the Ethernet interface controller 222 in the WCD 120 is via an Ethernet connection, and data communicated between the Ethernet interface controller 222 and the wireless communication module 224, within the WCD 120, is via a USB connection. The Ethernet interface controller 222 receives Ethernet data from the computing device 110, formats the data, and outputs it as USB data to the wireless communication module 224. Likewise, the Ethernet interface controller 222 receives USB data from the wireless communication module 224, formats the data, and outputs it as Ethernet data to the computing device 110. An advantage to this configuration is that many computing devices 110 have an Ethernet connection as a standard network interface, and many wireless communication modules have a USB port as a standard interface.

Using the Ethernet connection between the wireless communication device 120 and the computing device 110, such as a computer, the computing device 110 can receive services at or provide services to the wireless communication device 120. Types of services include the Internet service and/or other monitoring functions. For example, providing the monitoring functions for the wireless communication device 120 includes monitoring the status, changing operating parameters, running diagnostics, and otherwise providing functions related to status and management of the wireless communication device.

Advantages of using the Ethernet connection for communication between the wireless communication device and the computing device include: (1) absence of the need to provide a special cable appropriate for connecting the wireless communication device 120 to a UART controller in the computing device 110; (2) absence of the need to provide a USB device driver software compatible with an operating system 212 of the computing device 110; and (3) the ability to monitor/change the status and operation of the wireless communication device while simultaneously using the Internet connection of the wireless communication device.

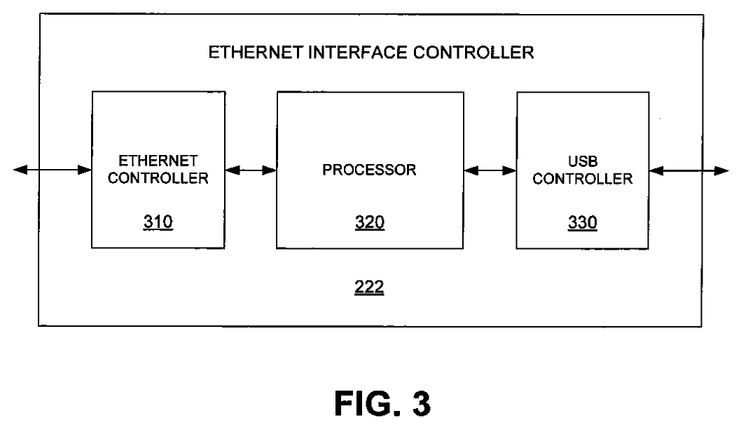

FIG. 3 is a block diagram illustrating further details of an example implementation of the Ethernet interface controller 222. As shown in the example of FIG. 3, the Ethernet interface controller 222 includes an Ethernet controller 310, a processor 320 and a universal serial bus (USB) controller 330. The processor 320 may include a central processing unit, as well as memory and peripheral controllers.

In one implementation, the Ethernet controller 310 receives Ethernet data from an external device, such as the computing device 110 of FIG. 2. The Ethernet controller 310 decodes and communicates the data to the processor 320. The processor 320 analyzes the data to determine if it is a request or command for status or management data of the wireless communication device, or if it is data for a wide area network, such as the Internet. The processor 320 then formats the data and communicates it to the USB controller 330 where it is output to the wireless communication module 224 (see FIG. 2). Likewise the USB controller 330 can receive USB data from the wireless communication module 224, decode it, and communicate the data to the processor 320. The processor 320 analyzes the data to determine if it is status and management data of the wireless communication device 120 or data from a wide area network, such as the Internet. The processor 320 then formats the data and communicates it to the Ethernet controller 310 where it is output to an external device, such as the computing device 110 of FIG. 2.

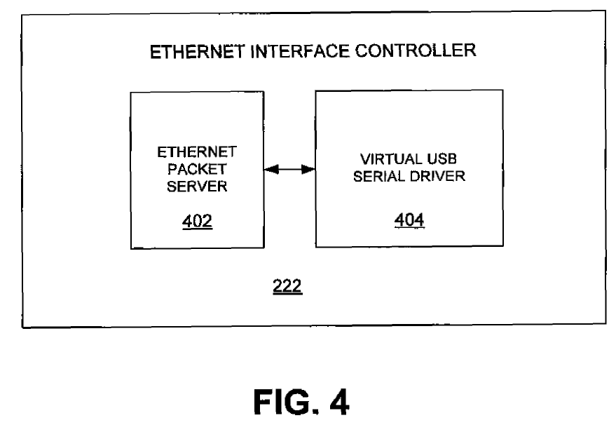

FIG. 4 is a block diagram illustrating another example implementation of the Ethernet interface controller 222. As shown in FIG. 4, the Ethernet interface controller 222 includes an Ethernet packet server 402 and a virtual USB serial driver 404. The Ethernet packet server 402 provides management of the connection between the Ethernet interface controller 222 and an external device, such as a computing device, using TCP/IP. The Ethernet packet server 402 also supports diagnostic monitoring protocol for status monitoring and status conversion. The diagnostic protocol enables an external device, such as a computing device, to monitor and manage the current status of the Ethernet interface controller 222 and a wireless communication module 224.

The virtual USB serial driver 404 provides an interface between the Ethernet interface controller 222 and the wireless communication module 224. The virtual serial driver 404 can be configured with one USB line, or channel, to provide service, status monitoring, status conversion, diagnostic monitoring, and another USB line for Network data, such as Internet communication.

While the examples described for the Ethernet interface controller 222 included a number of separate modules, the functions performed by the modules can be combined into a single module or any desired number of modules.

Communicating status and management data, as well as network data, such as Internet data, can use a technique referred to as two channel protocol. In one implementation of the two channel protocol, using USB communication between the USB controller 330 and the wireless communication module 224, the Ethernet interface controller 222 is able to simultaneously transmit and receive Internet and diagnostic data. To be able to receive and transmit the two types of information at the USB port of the USB controller 330, the information can be classified into different protocol channels. For example, one USB address, or channel, can be assigned to the Internet data, and a different USB address can be assigned to the diagnostic data. In this way, one type of data can be distinguished from another type of data. However, as many channels as desired can be used for classifying the data, up to the number of USB addresses available.

Following are several examples of providing a data interface with the Internet, and a data interface for status monitoring and selection.

In a first implementation of FIG. 2, devices and modules that provide a data interface with the Internet are configured as follows:

(1) Data flow from the Internet to the computing device 110 can occur as follows: the wireless communication device 120 receives data from the Internet through the antenna 226; the Internet data flows from the antenna 226 to the wireless communication module 224 and then to the Ethernet interface controller 222; and the Ethernet interface controller 222 directs/transmits the Internet data to the computing device 110 through an Ethernet connection.

(2) Data flow from the computing device 110 to the Internet can occur as follows: the computing device 110 directs/transmits data for the Internet to the Ethernet interface controller 222 through an Ethernet connection; data for the Internet flows from the Ethernet interface controller 222 to the wireless communication module 224, and then to the antenna 226; and the wireless communication device 120 transmits the data to the Internet through the antenna 226.

In a second implementation of FIG. 2, devices and modules that provide a data interface with the Ethernet interface controller 222 for status monitoring and selection are configured as follows:

(1) Data flow from the Ethernet interface controller 222 to the computing device 110 for status monitoring is as follows: data is delivered from the Ethernet interface controller 222 to the computing device 110 through an Ethernet connection; the data is then routed to the communication manager module 214 by an operating system 212 (including an Ethernet driver) in the computing device; and the communication manager module 214 monitors the status received from the Ethernet interface controller 222.

(2) Data flow from the computing device 110 to the Ethernet interface controller 222 for status selection/conversion is as follows: data is routed from the communication manager module 214 to the Ethernet driver in the computing device; and the data is then delivered from the computing device 110 to the Ethernet interface controller 222 through an Ethernet connection.

In a third implementation of FIG. 2, devices and modules that provide a data interface with the wireless communication module 224 for status monitoring and selection are configured as follows:

(1) Data flow from the wireless communication module 224 to the computing device 110 for status monitoring is as follows: data is delivered from the wireless communication module 224 to the Ethernet interface controller 222; the Ethernet interface controller 222 delivers the received data to the computing device 110 through an Ethernet connection to the Ethernet driver 212; the data is then routed to the communication manager module 214; and the communication manager module 214 is used to monitor the status of the wireless communication module 224.

(2) Data flow from the computing device 110 to the wireless communication module 224 for status selection/conversion is as follows: data is routed from the communication manager module 214 to an operating system 212 (including an Ethernet driver) in the computing device; the data is delivered from the computing device 110 to the Ethernet interface controller 222 through an Ethernet connection; and the data is then routed from the Ethernet interface controller 222 to the wireless communication module 224.

As shown in the implementations of FIG. 2, the modules can be configured to provide data interface with the Internet while simultaneously providing status monitoring and parameter selection of the Ethernet interface controller 222 and the wireless communication module 224. Thus, the steps listed under the second and third implementations can be executed simultaneously while the steps under the first implementation are being executed to provide data interface with the Internet.

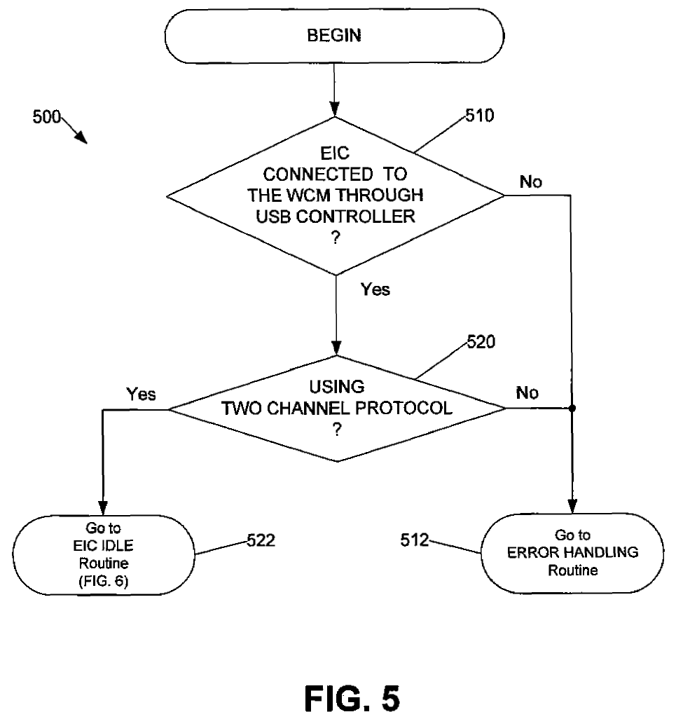

FIG. 5 is a flow diagram of an example initialization routine 500 for the Ethernet interface controller 222. The routine 500 determines if the Ethernet interface controller 222 is connected to the wireless communication module 224 through the USB controller, at block 510. If the Ethernet interface controller 222 is not connected to the wireless communication module 224, then the routine continues to an error-handling routine of block 512. Otherwise, if the Ethernet interface controller 222 is connected to the wireless communication module through the USB controller, then the routine 500 continues onto block 520. At block 520, it is determined if the Ethernet interface controller 222 is using a two-channel protocol. If the Ethernet interface controller 222 is not using a two-channel protocol, then routine 500 proceeds to an error-handling routine of block 512. If the controller is using a two-channel protocol, then routine 500 continues to the Ethernet interface controller idle routine 600, at block 522.

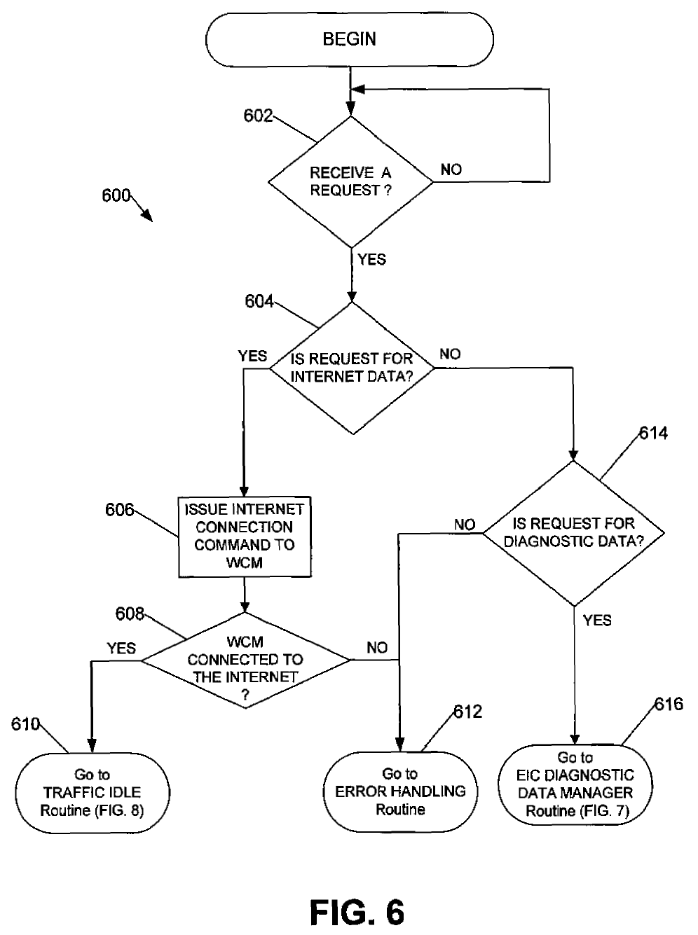

FIG. 6 is a flowchart illustrating an example of the Ethernet interface controller idle routine 600. In block 602, the Ethernet interface controller 222 determines if it has received a request. If a request has not been received, the routine 600 remains in block 602 waiting for a request.

When a request is received, the routine 600 continues to block 604 where it is determined if the request is for Internet data. If the request is for the Internet data, then the Ethernet interface controller 222 issues, at block 606, an Internet connection command to a wireless communication module 224. Then, at block 608, it is determined if the wireless communication module 224 successfully connected to the Internet. If the wireless communication module 224 successfully connected to the Internet, then the routine 600 continues to the traffic idle routine 800, at block 610. Returning to block 608, if the wireless communication module 224 did not successfully connect to the Internet, the routine 600 continues to the error handling routine, at block 612.

Returning to block 604, if the request is not for the Internet data, then it is determined, at block 614, if the request is for diagnostic data. If the request is for the diagnostic data, the routine 600 continues to the Ethernet interface controller (EIC) diagnostic data manager routine 700, at block 616. If the request is not for the diagnostic data, then the routine 600 continues to the error handling routine, at block 612.

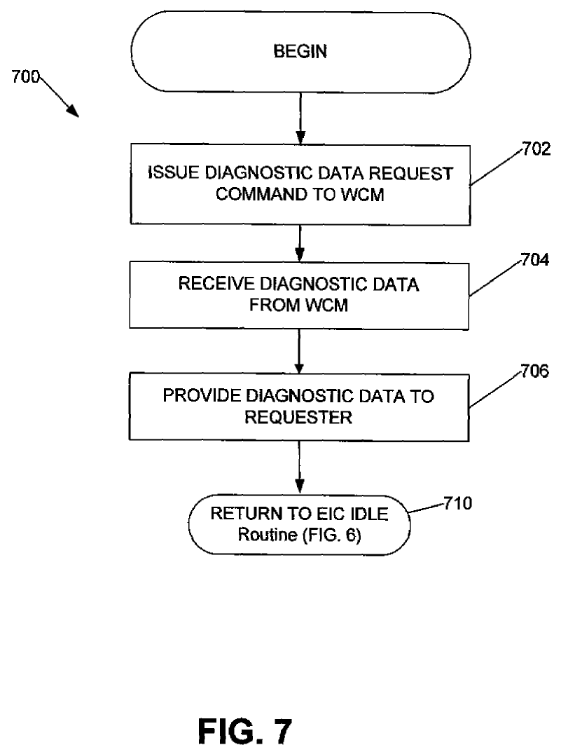

FIG. 7 is an example flow diagram of an EIC diagnostic data manager routine 700. In block 702, the Ethernet interface controller 222 issues a diagnostic data request command to the wireless communication module. Then, at block 704, the Ethernet interface controller 222 receives diagnostic data from the wireless communication module 224. At block 706, the Ethernet interface controller 222 provides the diagnostic data to the requester. The routine 700 then continues, and returns to the Ethernet interface controller idle routine 600, at block 710.

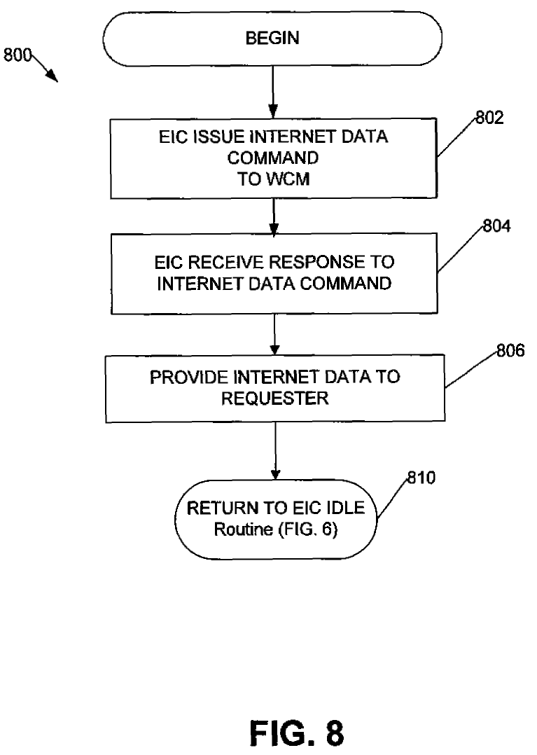

FIG. 8 is an example flow diagram of the Ethernet interface controller traffic idle routine 800. At block 802, the Ethernet interface controller 222 issues an Internet data command to the wireless communication module 224. Then, the Ethernet interface controller 222 receives a response to the Internet data command from the wireless communication module 224, at block 804. At block 806, the Internet data is provided to the requester. The routine 800 continues to block 810 and returns to the Ethernet interface controller idle routine 600.

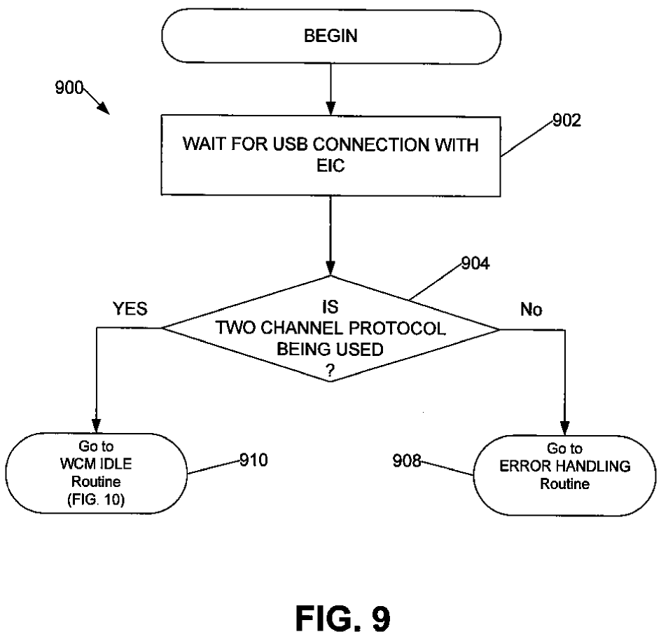

FIG. 9 is an example flow diagram of a wireless communication module initialization routine 900. In block 902, the wireless communication module 224 waits for a USB connection with the Ethernet interface controller 222. After the USB connection has been established, it is determined, at block 904, if a two-channel protocol is being used. If a two-channel protocol is not being used, then the routine 900 continues to an error routine, at block 908. If a two-channel protocol is being used, then the routine 900 continues to the wireless communication module idle routine 1000, at block 910.

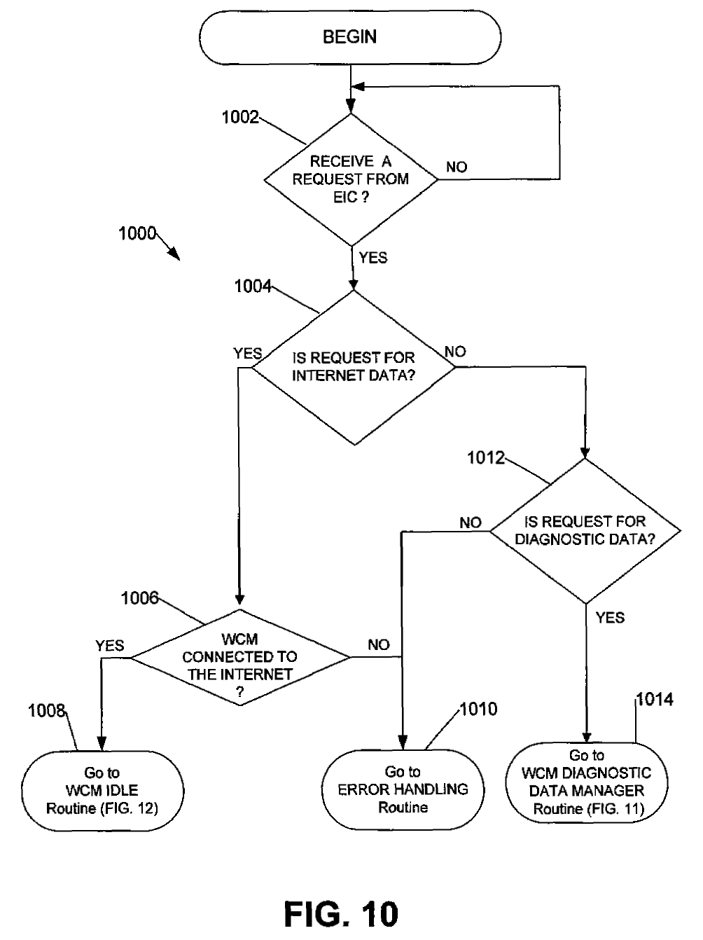

FIG. 10 is an example flow diagram of a wireless communication idle routine 1000. In block 1002, the wireless communication module 224 determines if it has received a request from the Ethernet interface controller 222. If the wireless communication module 224 has not received a request, the routine 1000 remains in block 1002. When a request is received, the routine 1000 continues to block 1004 where it is determined if the request is for Internet data. If the request is for the Internet data, then the wireless communication module 224 attempts to connect to the Internet, at block 1006. If the wireless communication module 224 is already connected to the Internet or can successful connect to the Internet, then the routine 1000 continues to the wireless communication module idle routine 1200, at block 1008. If the wireless communication module 224 is not successful in connecting to the Internet, the routine 1000 continues to an error handling routine, at block 1010.

Returning to block 1004, if the request is not for the Internet data, the routine 1000 continues to block 1012. At block 1012, it is determined if the request is for diagnostic data. If the request is for the diagnostic data, the routine 1000 continues to the wireless communication module diagnostic data manager routine 1100, at block 1014. If the request is not for the diagnostic data, routine 1000 continues to the error handling routine, at block 1010.

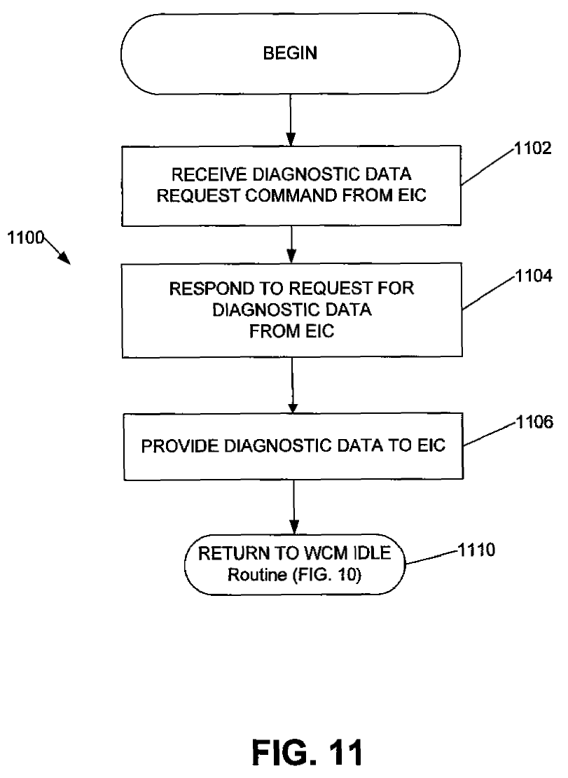

FIG. 11 is an example flow diagram of a wireless communication module diagnostic data manager routine 1100. At block 1102, the wireless communication module 224 receives a diagnostic data request command from the Ethernet interface controller 222. The wireless communication module 224 responds to the request for diagnostic data from the Ethernet interface controller 222, at block 1104. Then the wireless communication module 224 provides the diagnostic data to the Ethernet interface controller 222, at block 1106. The routine 1100 continues and returns to the wireless communication module idle routine 1000, in block 1110.

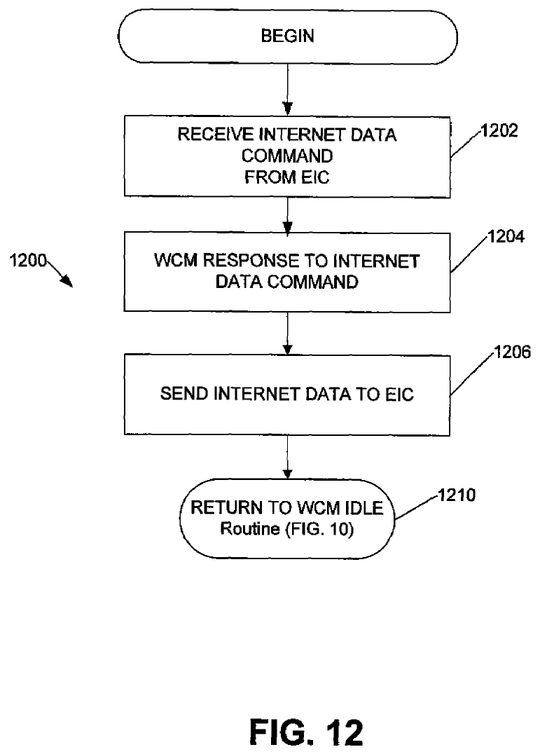

FIG. 12 is an example flow diagram of a wireless communication module traffic idle routine 1200. At block 1202, the wireless communication module 224 receives an Internet data command from the Ethernet interface controller 222. The wireless communication module 224 responds to the Internet data command, in block 1204. Then the wireless communication module 224 sends the Internet data to the Ethernet interface controller 222, at block 1206. The routine 1200 continues and returns to the wireless communication module idle routine 1000, at block 1210.

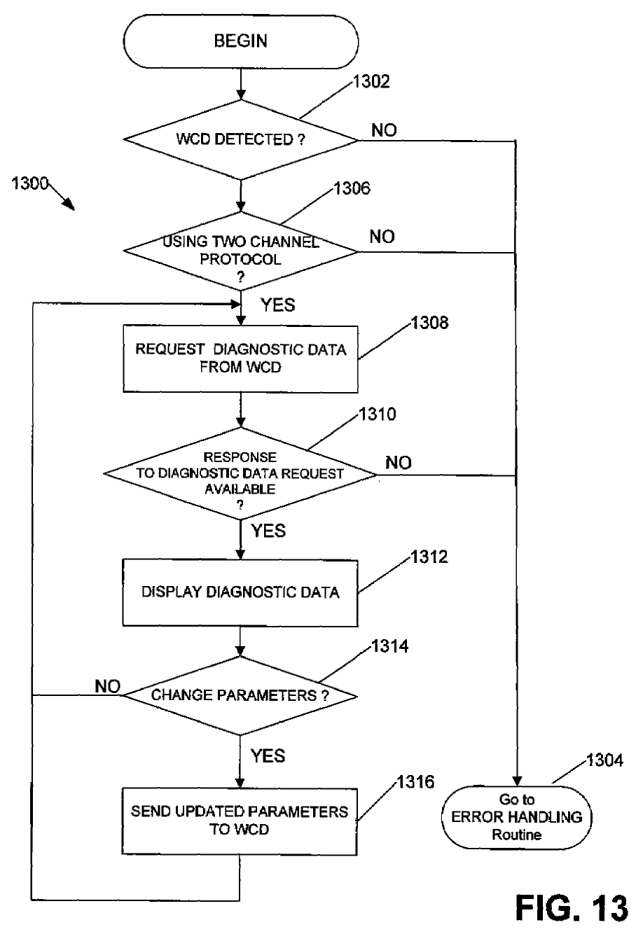

FIG. 13 is an example flow diagram 1300 of a communication manager (e.g., a communication manager module 214) for the wireless communication device (WCD) 120. At block 1302, the communication manager determines if a WCD 120 is detected. If no WCD 120 is detected, flow continues to the error handling routine, at block 1304. If a WCD 120 is detected, then it is determined if it is using a two-channel protocol, at block 1306. If it is not using a two-channel protocol, flow continues to the error handling routine of block 1304. If the WCD 120 is using a two-channel protocol, then diagnostic data is requested from the WCD 120, at block 1308. It is then determined if there is a response to the diagnostic data request available, at block 1310. If there is no response available, flow continues to the error handling routine of block 1304.

If (in block 1310) it is determined that there is a response available, then it is received and the diagnostic data is displayed, at block 1312. It is then determined, at block 1314, if it is desired to change any of the parameters of the WCD 120. If none of the parameters are to be changed, then the flow returns to block 1308. If at least one of the parameters in the WCD 120 are to be changed, then updated parameters are sent to the WCD 120, at block 1316. The flow then continues to 1308.

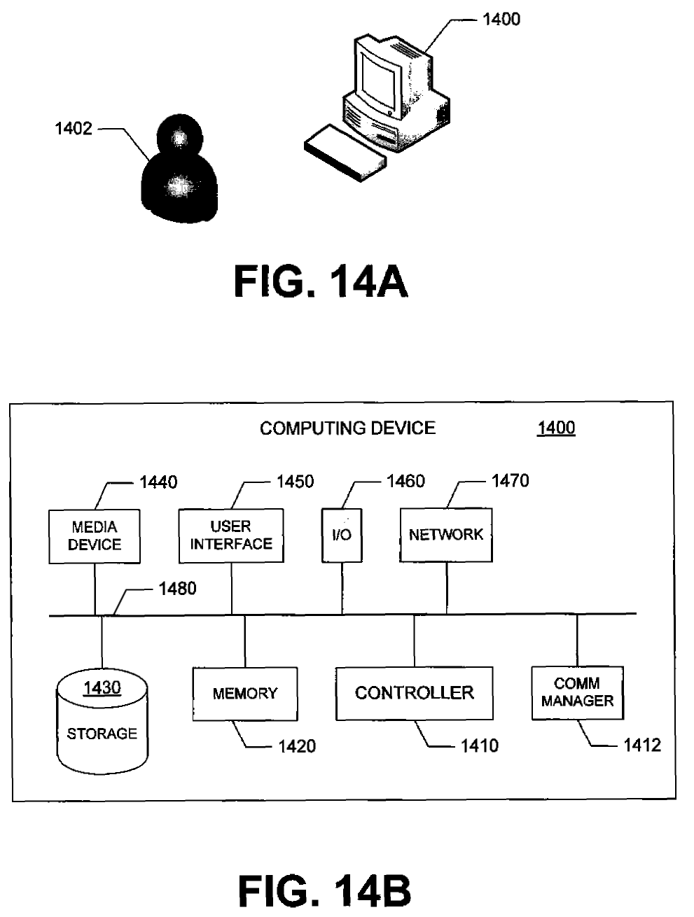

FIG. 14A shows a representation of a computer system 1400 and a user 1402. The user 1402 can use the computer system 1400 to interface with a wireless communication device 120 as described, for example, in FIGS. 1 and 2. The computer system 1400 stores and executes a communication manager 1412 for a wireless device (shown in FIG. 14B). In one example, the communication manager 1412 for the wireless device provides monitoring and status selection/conversion. Thus, in one implementation, the computer system 1400 is configured as the computing device 110 of FIG. 1; and the communication manager 1412 is configured as the communication manager module 214 of FIG. 2.

FIG. 14B shows a block diagram of one implementation of the computer system 1400 in FIG. 14A, including the communication manager 1412 for a wireless device (e.g., the wireless communication device 120 of FIG. 1). The computer system 1400 includes a controller 1410, a memory 1420, storage 1430, a media device 1440, a user interface 1450, an input/output (I/O) interface 1460, and a network interface 1470. These components are interconnected by a common bus 1480. Alternatively, different connection configurations can be used, such as a star pattern with the controller at the center.

The controller 1410 is a programmable processor and controls the operation of the computer system 1400 and its components. The controller 1410 loads instructions from the memory 1420 or an embedded controller memory (not shown) and executes these instructions to control the system. In its execution, the controller 1410 provides the communication manager 1412 for the wireless device as a software system. Alternatively, this service can be implemented as separate components in the controller 1410 or the computer system 1400.

Memory 1420 stores data temporarily for use by the other components of the computer system 1400. In one implementation, memory 1420 is implemented as RAM. In one implementation, memory 1420 also includes long-term or permanent memory, such as flash memory and/or ROM.

Storage 1430 stores data temporarily or long term for use by other components of the computer system 1400, such as for storing monitor and status data as used in the communication manager for a wireless device 1412. In one implementation, storage 1430 is a hard disk drive.

The media device 1440 receives removable media and reads and/or writes data to the inserted media. In one implementation, the media device 1440 is an optical disc drive.

The user interface 1450 includes components for accepting user input from the user of the computer system 1400 and presenting information to the user. In one implementation, the user interface 1450 includes a keyboard, a mouse, audio speakers, and a display. The controller 1410 uses input from the user to adjust the operation of the computer system 1400.

The I/O interface 1460 includes one or more I/O ports to connect to corresponding I/O devices, such as external storage or supplemental devices (e.g., a printer or a PDA). In one implementation, the ports of the I/O interface 1460 include ports such as: USB ports, PCMCIA ports, serial ports, and/or parallel ports. In another implementation, the I/O interface 1460 includes a wireless interface for communication with external devices wirelessly.

The network interface 1470 includes a wired and/or wireless network connection, such as an RJ-45 or “Wi-Fi” interface (802.11) supporting an Ethernet connection, which can be used to communicate with a wireless communication device.

The computer system 1400 includes additional hardware and software typical of computer systems (e.g., power, cooling, operating system), though these components are not specifically shown in FIG. 14B for simplicity. In other implementations, different configurations of the computer system can be used (e.g., different bus or storage configurations or a multi-processor configuration).

Various embodiments of the invention are realized in electronic hardware, computer software, or combinations of these technologies. Some embodiments include one or more computer programs executed by a computing device. For example, in one embodiment, the method for monitoring and/or converting the status, running diagnostics, and otherwise providing functions related to status and management of the wireless communication device includes one or more computers executing software implementing the monitoring and management functions. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description describes specific examples for monitoring, selecting, and/or converting the status, running diagnostics, and otherwise providing functions related to status and management of the wireless/cellular communication device using the Ethernet interface controller, the monitoring and management functions can be provided using other interface controllers similar to the Ethernet Controller.

Accordingly, the present invention is not limited to only those embodiments described above. Those of skill in the art will appreciate that the various illustrative modules and method steps described in connection with the above described figures and the implementations disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules and method steps described in connection with the embodiments disclosed herein can be implemented or performed with a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or routine described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

What is claimed is:

1. A method for managing communication between a wireless communication device and a computing device, comprising:
communicating Ethernet data from the computing device, wherein the data includes network data and diagnostic data;
assigning a first USB channel to the network data and a second USB channel to the diagnostic data;
communicating the first and second USB channels to a wireless communication module;
receiving two channels of USB data from the wireless communication module, wherein USB data assigned to the first channel is network data and data assigned to the second channel is diagnostic data; and
communicating the network data and diagnostic data to the computing device as Ethernet data.

2. The method of claim 1, wherein the diagnostic data comprises status data.

3. The method of claim 1, wherein the diagnostic data comprises control data.

4. The method of claim 1, wherein the network data comprises Internet data.

5. The method of claim 1, wherein communicating Ethernet data comprises wireless communication.

6. The method of claim 5, wherein communicating wirelessly comprises a Wi-Fi interface.

7. The method of claim 1, wherein communicating Ethernet data comprises wired communication.

8. The method of claim 1, wherein the first and second USB channels corresponds to first and second USB addresses.

9. A system for managing communication between a communication device and a computing device, comprising:
a communication manager module;
an Ethernet interface controller module in communication with the communication manager module; and
a wireless communication module in communication with the Ethernet interface controller module and in communication with a wireless network,
wherein the communication manager module manages the wireless communication module, and wherein communication between the Ethernet interface controller and the communication manager module comprises Ethernet communication and communication between the Ethernet interface controller module and the wireless communication module comprises USB communication.

10. The system of claim 9, wherein management of the wireless communication module comprises accessing status data about the communication module.

11. The system of claim 9, wherein management of the wireless communication module comprises accessing security control features of the wireless communication module.

12. The system of claim 9, wherein management of the wireless communication module comprises modifying service parameters of the wireless communication module.

13. The system of claim 9, wherein management of the wireless communication module comprises upgrading software of the wireless communication module.

14. The system of claim 9, wherein management of the wireless communication module comprises performing system test.

15. The system of claim 9, wherein the wireless network is the Internet.

16. The system of claim 9, wherein the USB communication comprises two channels.

17. The system of claim 16, wherein one of the channels communicates network data and the other channel communicates management data.

18. The system of claim 16, wherein the two channels correspond to two USB addresses.

19. A system for managing communication between a communication device and a computing device, comprising:
a computing device comprising a communication manager module adapted to perform management and diagnostic tasks; and
a wireless communication device comprising an Ethernet interface controller module and a wireless communication module,
wherein the Ethernet interface controller module is in communication with the communication manager module and the wireless communication module, and the wireless communication module is in communication with a wireless network,
wherein communication between the Ethernet interface controller and the communication manager module comprises Ethernet communication and communication between the Ethernet interface controller module and the wireless communication module comprises USB communication, and
wherein the communication manager module performs management and diagnostic tasks on the wireless communication module.

20. A system for managing communication between a communication device and a computing device, comprising:
means for communicating Ethernet data from the computing device, wherein the data includes network data and diagnostic data;
means for assigning a first USB channel to the network data and a second USB channel to the diagnostic data;
means for communicating the first and second USB channels to a wireless communication module;
means for receiving two channels of USB data from the wireless communication module, wherein USB data assigned to the first channel is network data and data assigned to the second channel is diagnostic data; and
means for communicating the network data and diagnostic data to the computing device as Ethernet data.
